(19) United States
(12) Patent Application Publication
(10) Pub. No.: US 2008/0258674 A1
(43) Pub. Date: Oct. 23, 2008

(54) Quickly charging power supply apparatus

(76) Inventors: David Hui, Taipei (TW); Wen-Feng Huang, Yung-Kang (TW); Yih-Wenn Luo, Yung-Kang (TW)

Correspondence Address: David Hui, P. O. Box 55-846, Taipei, 104, TW

(21) Appl. No.: 11/788,617

(22) Filed: Apr. 23, 2007

(51) Int. Cl. H02J 7/00

(52) U.S. Cl. 320/101; 320/137

(57) ABSTRACT

A power supply apparatus includes a power source; and at least a capacitor module formed by connecting a plurality of capacitors in series, having an input connector connected to a municipal power source supply or connected to a cigarette-lighter receptacle of a car for inputting direct current for quickly charging the capacitors of the capacitor module, and having an output connector connectable to a portable electric device including cellular phone and other portable devices each having rechargeable battery provided therein for quickly charging the portable electric device for keeping its continuous operation.

### BACKGROUND OF THE INVENTION

For charging a conventional cellular phone, it always requires a long time for charging the rechargeable battery provided in the cellular phone. Whenever someone is in a hurry to go out from his (her) office or home, his (or her) cellular phone will not be charged with enough power, thereby influencing the communication quality or effecting the related business or activities.

U.S. Pat. No. 6,501,246 disclosed a handy battery charger for charging a cellular phone by the electricity of a plurality of dry cells contained in the battery charger, which however has the following drawbacks:
1. A plurality of dry cells must be provided in the battery charger. Once the cells are in power failure, the charger will lose its effect for charging the cellular phone.
2. It still requires a long time for charging the cellular phone when connected on the battery charger. Before a saturated charging of the cellular phone, the charger including the upper and lower cases and the plural dry cells stored therein should be connected in situ with the cellular phone, thereby causing inconvenience or heavy carrying by the phone car.
3. For keeping the battery charger ready for use, the dry cells must be frequently checked to make sure that they are fully powered or recharged. The repeated replacement of new dry cells will be costly and may be unacceptable by the user.

The present inventor has found the drawbacks of the prior art and invented the present power supply apparatus for quickly charging a portable electric device.

### SUMMARY OF THE INVENTION

The object of the present invention is to provide a power supply apparatus including a power source; and at least a capacitor module formed by connecting a plurality of capacitors in series, having an input connector connected to a municipal power source supply or connected to a cigarette-lighter receptacle of a car for inputting direct current for quickly charging the capacitors of the capacitor module, and having an output connector connectable to a portable electric device including cellular phone and other portable devices each having rechargeable battery provided therein for quickly charging the portable electric device for keeping its continuous operation.

### BRIEF DESCRIPTION OF THE DRAWINGS

FIG. 1 shows a block diagram of the present invention.

FIG. 2 shows an electronic circuit of the present invention.

FIG. 3 shows another electronic circuit of the present invention.

FIG. 4 is a perspective view of the present invention.

FIG. 5 is a side view of the present invention.

FIG. 6 shows another modification of the present invention.

FIG. 7 shows a modification of the capacitor module as shown in FIG. 2.

FIG. 8 shows another preferred block diagram of the present invention.

### DETAILED DESCRIPTION

As shown in FIGS. 1, 2, 4 ad 5, a power supply apparatus 100 of the present invention comprises: a power source 1, an input connector 2 connected to the power source 1, a capacitor module 3 connected with the input connector 2, a voltage stabilizer module 4 connected to the capacitor module 3, and an output connector 5 connected with the voltage stabilizer module 4 and connectable to a portable electric (or electronic or computer) device P having at least a rechargeable battery provided in the portable electric device P.

The power source 1 includes: a municipal or utility power source, a power source of a vehicle (e.g. 12 volts), or a direct-current (DC) power source, or any other power sources, including electric energy converted by solar energy.

The input connector 2 may be an electric plug having a pair of pins or blades, connectable to a socket of municipal or utility power source with alternative current (such as 110 Volts); and a transformer and rectifier circuit connected to the electric plug for transforming and rectifying the AC current to DC current (such as 12V).

The input connector 2 may be a plug pluggable or insertable in a cigarette-lighter receptacle of a vehicle or car for directing the DC power (such as 12 volts) from the car battery into the capacitor module 3.

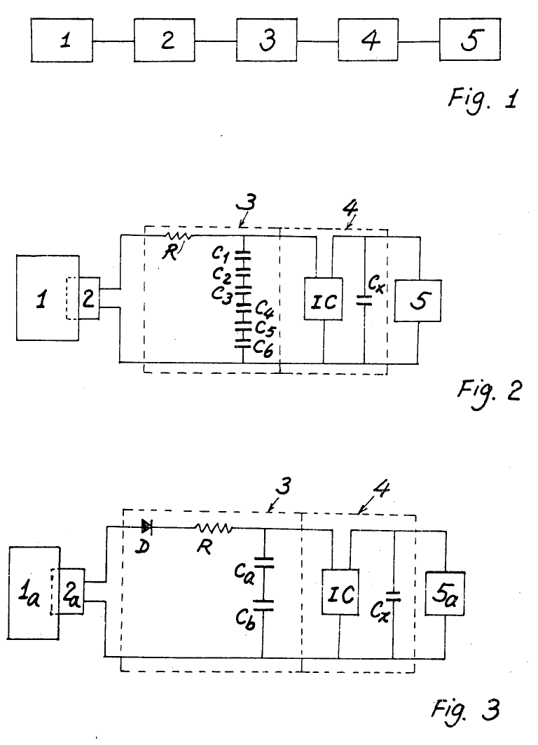

The capacitor module 3 includes a plurality of capacitors, C₁, C₂, C₃, C₄, C₅, C₆, etc., connected in series as shown in FIG. 2 across the positive pole and the negative pole of the power source 1; and a resistor R connected in series with the capacitors (C₁˜C₆) and the power source 1 for forming the time constant (TC=R×C) of the present invention.

The voltage stabilizer module 4 includes a voltage stabilizing integrated circuit IC for regulating or stabilizing the voltage output from the capacitors (C₁˜C₆), and a filtering capacitor Cx connected in parallel with the voltage stabilizing integrated circuit IC for filtering any interference waves of an output voltage, which is output through the output connector 5.

An example showing the related design data is given as follows:

R=2 ohms,

C₁˜C₆, each being 25 F,

Total capacitance, C=4.17 F,

The charging time, T (seconds), is thus obtained as:

T=1.1RC=1.1×2×4.17=9.17

Accordingly, after 9.17 seconds, the capacitors can be charged to reach a voltage of 12 volts, which is then regulated and stabilized by the voltage stabilizer module 4 to be 5 volts, which is then output through the output connector 5.

A portable electric device P such as a cellular phone may be connected to the output connector 5 to be charged by the present invention. The charging or discharging time is only 9.17 seconds as above-mentioned, thereby quickly charging the portable electric device P in accordance with the present invention.

Since a conventional cellular phone generally requires an input voltage of 2.4˜4.8 volts. The output voltage of 5 volts as effected by the present invention is enough for charging the cellular phone P.

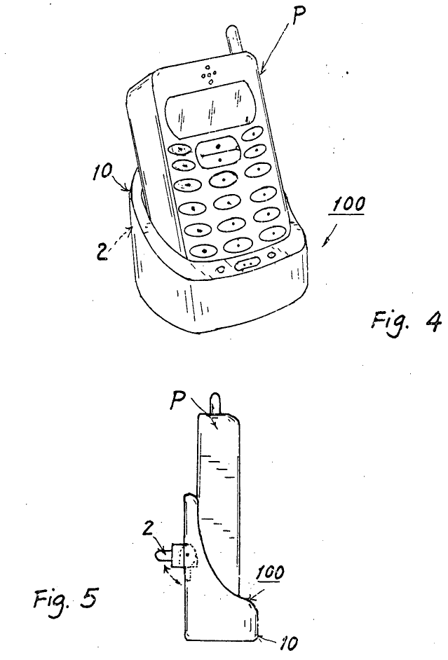

The elements, circuits and modules of the present invention 100 may be mounted in a holder casing 10 as illustrated in FIGS. 4 and 5, of which the input connector 2 may be a plug rotatably mounted on a back portion of the casing 10 to be plugged in a power socket of a municipal power source supply.

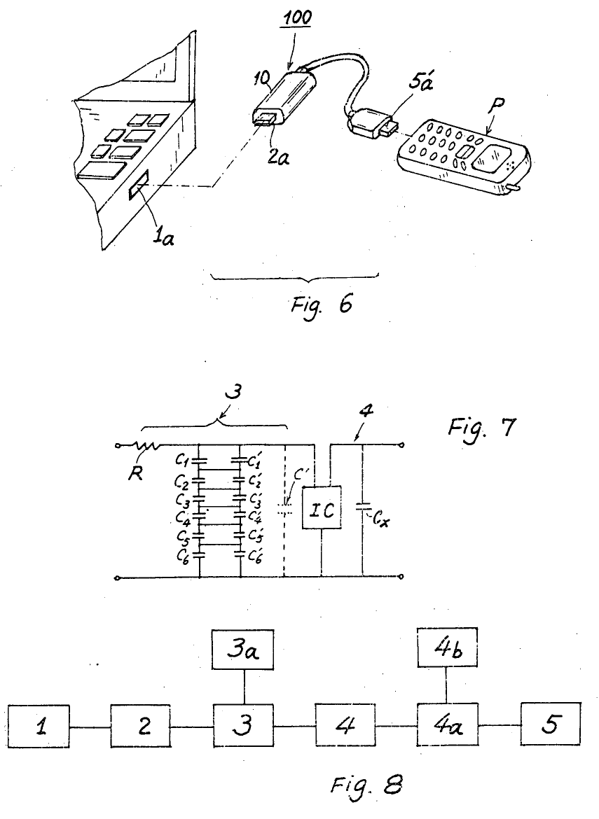

Another preferred embodiment of the present invention is shown in FIGS. 3 and 6, which is modified from the circuit as shown in FIG. 2 and the modifications are described hereinafter.

The power source 1a is now directly supplied from a computer as connected to an output power terminal of the computer (FIG. 6).

As shown in FIG. 3, the input connector is now modified to be a USB (universal serial bus) input connector 2a; while the output connector modified to be a USB output connector 5a. In FIG. 6, the output connector is a cable adapter 5′a connectable to a cellular phone P.

A diode D may be provided between the power source 1a and the capacitors Ca, Cb connected in series for ensuring an input of direct current from the computer terminal.

The voltage of each capacitor Ca or Cb may be different from that of the aforementioned capacitors C₁˜C₆ since the computer will not provide a high current as compared with the larger current provided by a car battery.

The portable electric (or electronic or computer) device P of the present invention may include: a cellular phone, a portable data store, MP3, MP4, iPod, PDA, GPS, PSP, NB, a multi-media device, and other USB-related devices, etc., not limited in the present invention.

As shown in FIG. 7, each capacitor C₁˜C₆ of the capacitor module 3 may be connected in parallel with each capacitor C′₁˜C′₆ with micron-farads for preventing noise interference. The capacitors C′₁˜C′₆ may be represented by a capacitor C′ as shown in dotted line.

Another preferred modification of the present invention is shown in FIG. 8, as modified from that as shown in FIG. 1.

A battery module 3a is electrically connected to the capacitor module 3 as shown in FIG. 8 to allow the excess electricity after charging the capacitors C₁˜C₆ of the capacitor module 3 to charge the chargeable battery of the battery module 3a for storing the electric energy ready for next use.

A programmable voltage adjusting module 4a is connected to the voltage stabilizer module 4, including a microprocessor for programming the desired pre-set output voltage values, of which a desired output voltage may be selected by the user, as output through the output connector 5.

A display module 4b is connected to the programmable voltage adjusting module 4a, having at least a light-emitting diode (LED) or liquid crystal display provided in the display module 4b for showing the output voltage value as output from the programmable voltage adjusting module 4a.

Such a modification as shown in FIG. 8 may further enhance the functions of the present invention, based on the embodiment as shown in FIG. 1.

The present invention is superior to the prior art with the following advantages:
1. The portable electric or electronic device P may be sooner and conveniently charged by the electric energy as quickly charged in the apparatus of this application, without a long-time waiting as required by a conventional battery charger.
2. The heavy dry cells or batteries as needed for charging a portable electronic device, such as a cellular phone, are no longer required to be carried or kept on hand by the user.
3. The portable electric or electronic device may be easily charged by a power supply source from a city utility power source, a vehicle battery, a computer power source or any other sources.

The present invention may be further modified without departing from the spirit and scope of the present invention.

I claim:

1. A power supply apparatus comprising:
an input connector connected to a power source for supplying a direct-current (DC) power source;
a capacitor module connected with said input connector for charging a plurality of capacitors connected in series in between a positive pole and a negative pole of said power source;
a voltage stabilizer module connected to said capacitor module for stabilizing and regulating an output voltage; and
an output connector connected to a portable electric device having a rechargeable battery provided in said portable electric charge, and operatively charging said portable electric device by said output voltage as output through said output connector.

2. A power supply apparatus according to claim 1, wherein said power source is selected from a group of power sources consisting of: a municipal power source, a vehicle battery, and a computer power source and a power source as converted by solar energy.

3. A power supply apparatus according to claim 1, wherein said input connector is a cigarette-lighter plug connected to a cigarette-light receptacle of a vehicle battery.

4. A power supply apparatus according to claim 1, wherein each said connector of said input connector and said output connector is an universal serial bus (USB) connector.

5. A power supply apparatus according to claim 1, wherein said capacitor module includes a plurality of said capacitors connected in series in between said positive and negative poles of said power source; and a resistor connected in series with said capacitors and said power source.

6. A power supply apparatus according to claim 1, wherein said voltage stabilizer module includes a voltage stabilizing integrated circuit for stabilizing an output voltage from said capacitor module, and a filtering capacitor connected in parallel with said voltage stabilizing integrated circuit for filtering any interference wave of said output voltage.

7. A power supply apparatus according to claim 1, wherein said capacitor module further includes a battery module electrically connected to said capacitor module to allow an excess electricity from said capacitor module to charge a chargeable battery of said battery module.

8. A power supply apparatus according to claim 1, wherein said voltage stabilizer module further includes programmable voltage adjusting module, which is connected to said voltage stabilizer module, and includes a microprocessor for programming at least a pre-set output voltage value therein.

9. A power supply apparatus according to claim 1, wherein said programmable voltage adjusting module further includes a display module connected to said programmable voltage adjusting module, having at least a light-emitting diode or liquid crystal display provided in the display module for showing an output voltage value as output from the programmable voltage adjusting module.

10. A power supply apparatus according to claim 5, wherein each said capacitor of said capacitor module is connected in parallel with a capacitor of micron-farads for preventing noise interference.
